(19) United States
(12) Patent Application Publication
(10) Pub. No.: US 2004/0051348 A1
(43) Pub. Date: Mar. 18, 2004

(54) Openable motor vehicle roof

(75) Inventors: Francois De Gaillard, Mouilleron en Pareds (FR); Martin De Waal, TS Assendelft (NL); Jean-Luc Guicheteau, Cholet (FR); Izumi Kimoto, Hiroshima-ken (JP); Michael Kolbl, Neuried (DE); Peter Mitterbauer, Gmunden (AT); Martin Pollak, Germering (DE); Claudio Ivano Righetti, Torino (IT); Miriam Schonauer, Garching (DE); Sigeru Ueki, Higashihiroshima-City (JP); Bernhard Vecchioni, Oxford, MI (US)

Correspondence Address: NIXON PEABODY, LLP, 401 9TH STREET, NW, SUITE 900, WASINGTON, DC, 20004-2128, US

(73) Assignee: Webasto Vehicle Systems International GmbH, Stockdorf (DE)

(21) Appl. No.: 10/411,386

(22) Filed: Apr. 11, 2003

(30) Foreign Application Priority Data
Apr. 11, 2002 (DE) 102 15 966.1

(51) Int. Cl. B60J 7/047

(52) U.S. Cl. 296/220.01

(57) ABSTRACT

An openable motor vehicle roof with a set (20) of several raisable louvers (22) which are arranged in succession in the lengthwise direction of the vehicle, which lie flat side-by-side next to one another in the closed position in order to close the roof opening (10), and which can be pushed into the form of a packet in which they lay parallel to, and on top of, one another in the raised state in order to at least partially clear the roof opening. The roof opening (10) extends to underneath the equator (18) of the motor vehicle in the rear area of the motor vehicle.

### BACKGROUND OF THE INVENTION

1. Field of the Invention

This invention relates to an openable motor vehicle roof with a set of several raisable louvers which are arranged in succession in the lengthwise direction of the vehicle, which lie flat side-by-side with each other in the closed position of the roof in order to close the roof opening, and which can be pushed into a packet in which the louvers are arranged parallelly on top of one another in a raised state in order to at least partially clear the roof opening.

2. Description of Related Art

Motor vehicle roofs of the initially mentioned type have been known for a long time and are conventionally called louvered roofs, and in which the roof opening has been limited to an area above the vehicle passengers.

Published European Patent Application EP 1 006 013 A1 discloses a motor vehicle in which the roof opening extends from the windshield to the loading edge of the rear stowage space, there being a set of louvers to close the entire roof opening in the closed position. In doing so, the louvers lie flat side-by-side next to one another, the rear window being integrated into the set of louvers. Adjacent louvers are joined to one another by means of a hinge arrangement; the louvers, when the roof opening is to be partially or completely cleared, can be folded onto one another. The louvers are each guided laterally in a body-mounted guide. To completely clear the roof opening, the louvers can be deposited in a storage area behind the back seats in the folded state.

U.S. Pat. No. 2,086,091 discloses a truck with a cargo area which can be covered to the top and rear by a cover set formed of several successive covers which are connected to one another in the manner of a hinge. The opening which is to be closed by the cover set extends from the front edge of the cargo area to the rear cargo edge. In order to clear the cargo area, the covers can be deposited, folded onto one another, on the front end of the cargo area.

Published German Patent Application DE197 38 281 discloses a passenger vehicle made as a pick-up truck in which the roof opening extends from the windshield to the loading edge of the rear stowage space and which can be closed by a fabric roof which can be rolled in the area of the windshield onto a take-up roller or can be unwound from it.

### SUMMARY OF THE INVENTION

The primary object of the present invention is to devise an openable motor vehicle roof with a set of louvers which enables simple and convenient loading of a rear stowage space and still allows simple and mechanically reliable guidance of the set of louvers.

This object is achieved in accordance with the invention by a motor vehicle roof. In which the roof opening extends in the rear area of the motor vehicle to underneath the equator of the motor vehicle. This approach is advantageous because, by having the roof opening extend to below the equator of the vehicle, comfortable loading of the rear stowage space without the disruptive rear hatch is enabled, and in addition, because the louvers can be pushed over one another into a packet-like configuration in the open position, simple guidance of the louvers without the need for a folding capacity of the louvers is possible. In particular, a pleasant visual appearance and stable covering in the closed state can be achieved.

Preferred embodiments of the invention are described in detail below, by way of example, with reference to the accompanying drawings.

### BRIEF DESCRIPTION OF THE DRAWING

FIG. 1 is a schematic perspective view of a motor vehicle roof in accordance with the invention in the closed position and

FIG. 2 shows a view similar to FIG. 1, however the motor vehicle roof being shown with the rear area opened.

### DETAILED DESCRIPTION OF THE INVENTION

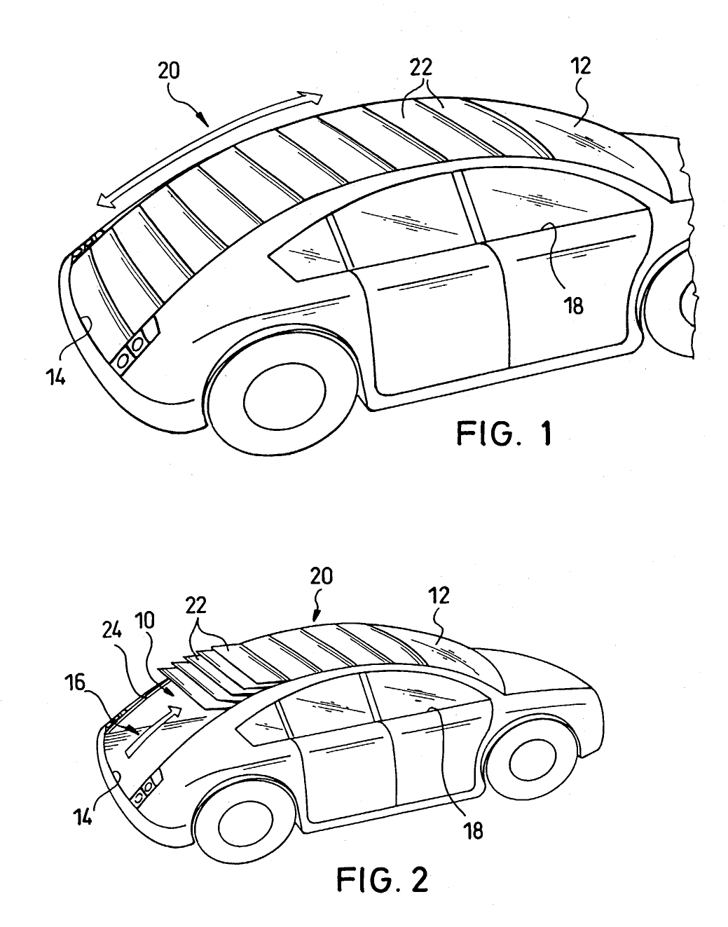

In FIG. 1, a vehicle has a roof opening 10 which extends from the front windshield 12 to a loading edge 14 of the rear stowage space 16. The loading edge 14, here, lies underneath the equator 18 of the vehicle. There is a set of louvers 20 for closing the roof opening 10 that are selectively movable into the closed position shown in FIG. 1, or positions at least partially clearing the roof opening 10, see FIG. 2.

The set of louvers 20 comprises a plurality of louvers 22 which are guided laterally in a body-mounted guide 24 which extends on each of the two opposite side edges of the roof opening 10. The louvers 22 are made as in a conventional louvered roof such that in the closed position they lie flat, side-by-side with one another in order to close the roof opening 10, the louvers 22 being coupled to one another such that they can be raised upward at their rear edge and can be pushed over one another parallel in the raised position in order to form a package of louvers. In doing so, the opening of the set 20 of louvers can take place by either the frontmost or the rearmost louver being pushed to the front or back by means of a drive, by which the other louvers are entrained into corresponding displacement, the raising motion of the louvers, beginning with the rearmost louver, taking place automatically. With the roof opening 10 completely opened, the louvers 22 form a set of louvers which, depending on the direction of opening, lies on the front or back end of the roof opening 10 and is composed of raised louvers 22 which are adjacent to one another in parallel. Mechanisms for producing such movements are known and by themselves, form no part of this invention; see, U.S. Pat. No. 4,911,496 and U.S. Pat. No. 5,897,160, which is hereby incorporated by reference as an example of such a mechanism as can be adapted for use in accordance with the present invention.

The set 20 of louvers can be opened by actuating the drive proceeding from the closed position shown in FIG. 1 by moving the rearmost louver in the forward direction, by which, first of all, beginning from the loading edge 14, the rear stowage space is cleared for loading or unloading. If the rearmost louver is pushed further forward beyond the position shown in FIG. 2, in this way, the part of the roof opening 10 which lies over the passengers can be cleared for ventilation purposes, for a completely cleared roof opening, the louvers 22 reaching the front edge of the roof opening 20 as a package.

Conversely, if not the rear area, but only the area of the roof opening 10 above the passengers is to be cleared, this can take place by the frontmost louver being pushed rearward via a drive in order to push the louvers over one another in the area of the rear stowage space.

In the third opening version, proceeding from the position shown in FIG. 2, with the rear stowage space 16 cleared the frontmost louvers can be pushed to the rear by means of the drive so that the louvers in the area between the rear stowage space 16 and the area above vehicle passengers are pushed together to form a package of louvers.

Actuation of the frontmost or rearmost louver takes place preferably via a respective separate drive.

What is claimed is:

1. Openable motor vehicle roof with a vehicle body having a roof opening and with a set of several raisable louvers which are arranged in succession in the lengthwise direction of the vehicle, which lie flat side-by-side next to one another in a closed position to close the roof opening, and which can be pushed into an arrangement in the form of a packet in which the louvers are disposed in parallel one over another in a raised state to at least partially clear the roof opening, wherein the roof opening extends to underneath an equator of the motor vehicle in a rear area of the motor vehicle body.

2. Motor vehicle roof as claimed in claim 1, wherein the roof opening extends to a loading edge of a rear stowage space of the motor vehicle body.

3. Motor vehicle roof as claimed in claim 2, wherein the set of louvers is upwardly pushable together by means of a drive, proceeding from the loading edge, forward into a loading position for loading of the rear stowage space, the vehicle interior is being closed from above by the set of louvers in said loading position.

4. Motor vehicle roof as claimed in claim 1, wherein the set of louvers are pushable together proceeding from a front edge of the roof opening to the rear by means of a drive to at least partially clear the roof opening in an area of a passenger compartment of the vehicle body.

5. Motor vehicle roof as claimed in claim 1, wherein proceeding from a front edge of the roof opening and a rear edge of the roof opening, the set of louvers is pushable together in a middle section of the roof opening to clear the roof opening both in an area of a passenger compartment and also in an area of a rear stowage space of the vehicle body.

6. Motor vehicle roof as claimed in claim 1, wherein a separate drive is provided for opening the set of louvers from each of the front and the back of the roof opening.

7. Motor vehicle roof as claimed in claim 3, wherein the set of louvers are pushable together proceeding from a front edge of the roof opening to the rear by means of a drive to at least partially clear the roof opening in an area of a passenger compartment of the vehicle body.

8. Motor vehicle roof as claimed in claim 7, wherein, proceeding from a front edge of the roof opening and a rear edge of the roof opening, the set of louvers is pushable together in a middle section of the roof opening to clear the roof opening both in an area of a passenger compartment and also in an area of a rear stowage space of the vehicle body.

9. Motor vehicle roof as claimed in claim 8, wherein a separate drive is provided for opening the set of louvers from each of the front and the back of the roof opening.
